(19) United States
(12) Patent Application Publication
(10) Pub. No.: US 2026/0305620 A1
(43) Pub. Date: Oct. 8, 2026

(54) NOVEL INSECTICIDAL MIXTURES FOR CONTROLLING AND PROTECTING CROPS

(71) Applicant: ADAMA MAKHTESHIM LTD., Beer Sheva (IL)

(72) Inventors: Lior WALDMAN, Herzeliya (IL); Nimrod REZNIK, Beer Sheva (IL); Andrew HORSFIELD, Brisbane, Queensland (AU); Mariela FAURE MLYNSKI, Gedera (IL)

(73) Assignee: ADAMA MAKHTESHIM LTD., Beer Sheva (IL)

(21) Appl. No.: 19/482,499

(22) PCT Filed: May 8, 2024
(86) PCT No.: PCT/IL2024/050444

§ 371 Date: Nov. 7, 2025

Related U.S. Application Data
(60) Provisional application No. 63/464,640, filed on May 8, 2023.

(51) Int. Cl. A01N 65/42; A01P 7/02; A01P 7/04

(52) U.S. Cl. CPC A01N 65/42; A01P 7/02; A01P 7/04

(57) ABSTRACT

The present invention relates to an agrochemical insecticidal mixture comprising combination of a bioactive agent selected from garlic extract, garlic oil, and the mixture thereof with additional insecticide selected from the group consisting of neonicotinoids, pyrethroids, pyropenes, diamides, benzoylureas, METI acaricides, METI insecticides, mesoionics, pyridine azomethine derivatives, tetronic and tetramic acid derivatives, phenylpyrazoles, flonicamid, benzpyrimoxan, sulfoxaflor and the mixtures thereof, and the method for controlling pests and protecting crops against pests' infestation comprising treating the crop with an effective amount of said agrochemical insecticidal mixtures.

### FIELD OF INVENTION

The present invention relates to an agrochemical insecticidal mixture comprising combination of a bioactive agent selected from garlic extract, garlic oil, and the mixture thereof with additional insecticide, and the method for controlling pests and protecting crops against pests' infestation comprising treating the crop with an effective amount of said agrochemical insecticidal mixtures.

### SUMMARY

The present invention provides an insecticidal mixture comprising a) a bioactive agent selected from garlic extract, garlic oil, and the mixture thereof; and b) an additional insecticide selected from the group consisting of neonicotinoids, pyrethroids, pyropenes, diamides, benzoylureas, METI acaricides, METI insecticides, mesoionics, pyridine azomethine derivatives, tetronic and tetramic acid derivatives, phenylpyrazoles, flonicamid, benzpyrimoxan, sulfoxaflor and the mixtures thereof.

This invention is further directed to a method for controlling pests comprising treating the infected crop with an effective amount of the insecticidal mixture comprising a) a bioactive agent selected from garlic extract, garlic oil, and the mixture thereof; and b) an additional insecticide selected from the group consisting of: neonicotinoids, pyrethroids, pyropenes, diamides, benzoylureas, METI acaricides, METI insecticides, mesoionics, pyridine azomethine derivatives, tetronic and tetramic acid derivatives, phenylpyrazoles, flonicamid, benzpyrimoxan, sulfoxaflor and the mixtures thereof.

This invention is further directed to a method for protecting crop from pests' infestation comprising treating the crop with an effective amount of the insecticidal mixture comprising a) a bioactive agent selected from garlic extract, garlic oil, and the mixture thereof; and b) an additional insecticide selected from the group consisting of: neonicotinoids, pyrethroids, pyropenes, diamides, benzoylureas, METI acaricides, METI insecticides, mesoionics, pyridine azomethine derivatives, tetronic and tetramic acid derivatives, phenylpyrazoles, flonicamid, benzpyrimoxan, sulfoxaflor and the mixtures thereof.

### BACKGROUND

The cotton aphid, scientifically known as Aphis gossypii, is a small insect that belongs to the family Aphididae (Aphidoidea). It is a common pest in agriculture, particularly in cotton crops, but it can also infest various other plants such as vegetables, fruits, and ornamental plants.

Cotton aphids feed on plant sap by using their needle-like mouthparts to pierce plant tissues and extract nutrients. As they feed, they can cause damage to the plants by stunting growth, reducing yields, and transmitting certain plant viruses. Additionally, they secrete a sticky substance known as honeydew, which can attract other pests like ants and lead to the growth of sooty mold on plants.

Control measures for cotton aphids often include the use of insecticides, natural predators (such as ladybugs and parasitic wasps), and cultural practices like crop rotation. Monitoring and early detection are crucial for effective management of cotton aphid infestations in agricultural settings.

Pesticides are chemical substances that are used to control or eliminate pests, such as insects, weeds, and plant diseases, in crops. They are aimed to increase yields by protecting crops from damages caused by pests, which can result in higher yields and better quality of crops, and in terms of reducing crop loss, increase cost-effectivenes and efficiency. Pesticides are easy to apply and can be used to treat large areas quickly and efficiently.

Several pesticides are commonly used to control cotton aphids in agricultural settings. It's important to note that the choice of pesticide may depend on various factors, including the severity of the infestation, the specific crop, and local regulations. Some common types of pesticides used for controlling cotton aphids are neonicotinoids insecticides, pyrethroids insecticides, organophosphates insecticides, that act on the nervous system of the aphids. In addition, Insect Growth Regulators (IGRs), disrupt the growth and development of the insects and are often used as a part of integrated pest management (IPM) programs.

Although the use of chemical pesticides can help control pests, this approach may have environmental and health consequences. Most of the pesticides are toxic and can lead to environmental impact harming non-target species, soil, water, and air contamination. In some cases, toxic pesticide residues can remain on crops even after they are harvested and processed that eventually can end up in the food supply, potentially posing risks to human health. Prolonged or excessive use of pesticides can lead to the development of pesticide-resistant pests. Pesticides can pose health risks to humans, especially those who work with or are exposed to these chemicals regularly.

In recent years, there has been an increase in the use of natural pesticides and natural repellents (bioactive agents), which are typically associated with organic farming and integrated pest management (IPM). The following prior arts illustrate this trend: WO2006/109028, WO2020/067867, and Lamba K, et al. 2020. This trend has been driven by several important considerations, including reducing the environmental impact when compared to synthetic chemical pesticides, having lower environmental persistence, and being less harmful to non-target organisms like beneficial insects, birds, and aquatic life. Additionally, it is important to maintain resistance management to prevent the development of resistance in pest populations against chemical pesticides. Regulatory compliance, human health concerns, sustainability, and consumer preference for organic products are also factors that contribute to the use of natural-repellent pesticides.

Bioactive agents such as garlic extract, and garlic oil are well-known natural pesticides and repellents that have high efficacy against pests. Its composition, which includes a mixture of sulfide derivatives and other hydrophilic and hydrophobic compounds, has attracted significant interest among researchers who seek to understand its specific composition (Block E. 2010, Khan I. A and Abourashed E. A. 2010, Moore S. J. and Lenglet A. D. 2004), its various modes of action against pests (Plata-Rued et al. 2017, Singh and Singh. 1996, Halliwell and Gutteridge, 1999, Correa et al. 2015, De Araujo et al 2017), and its potential use in agricultural crop protection (Upadhyay and Singh, 2012, Chang et al. 2017, Sheh et al. 2021). However, it is worth noting that while natural repellent pesticides have their advantages, their efficacy can vary, and they may need to be used in combination with other pest management strategies to achieve optimal results.

### DETAILED DESCRIPTION OF INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains. The following definitions are provided for clarity.

The term “a” or “an” as used herein includes the singular and the plural, unless specifically stated otherwise. Therefore, the terms “a,” “an,” or “at least one” can be used interchangeably in this application.

As used herein, the verb “comprise” as is used in this description and the claims and its conjugations are used in its non-limiting sense to mean that items following the word are included, but items not specifically mentioned are not excluded. Throughout the application, descriptions of various embodiments use the term “comprising”; however, it will be understood by one of skill in the art, that in some specific instances, an embodiment can alternatively be described using the language “consisting essentially of” or “consisting of.”

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention.

As used herein, the term “effective amount” refers to an amount of the active component that is commercially recommended for use to control and/or prevent pests. The commercially recommended amount for each active component, often specified as the application rates of the commercial formulation, may be found on the label accompanying the commercial formulation. The commercially recommended application rates of the commercial formulation may vary depending on factors such as the plant species and the pest to be controlled.

As used herein, the term “mixture” or “combination” refers, but is not limited to, a combination in any physical form, e.g., blend, solution, alloy, or the like.

The term “health of a plant” comprises various sorts of improvements of plants that are not connected to the control of pests. For example, advantageous properties that may be mentioned are improved crop characteristics including emergence, crop yields, protein content, oil content, starch content, more developed root system (improved root growth), improved stress tolerance (e.g. against drought, heat, salt, UV, water, cold), reduced ethylene (reduced production and/or inhibition of reception), increase in plant height, bigger leaf blade, less dead basal leaves, stronger tillers, greener leaf color, pigment content, photosynthetic activity, fewer input needed (such as fertilizers or water), less seeds needed, more productive tillers, earlier flowering, early grain maturity, fewer plant verse (lodging), increased shoot growth, enhanced plant vigor, increased plant stand and early and better germination; or any other advantages familiar to a person skilled in the art.

The term “in the absence of insect pest pressure” refers to conditions in which insect pests are not present in the growth area of a plant, as well as to the conditions in which such insect pests are present within the area of growth of a plant in a quantity which is not harmful to the plant, and which does not interfere with the growth of the plant.

The term “plant growth” refers to the process of improving and promoting plant development to achieve better yields and healthier plants.

The term “yield” refers to increasing the quantity or quality of crops or plant products harvested from a given area of land or a specific plant.

The term “plant development” refers to the process of promoting and improving various aspects of a plant's growth and life cycle. Enhancing plant development includes the following aspects:
1. Promoting Growth is established by encouraging the plant to grow larger, taller, or more vigorously, often through providing adequate nutrients, water, and optimal growing conditions.
2. Accelerating Maturation is established by speeding up the plant's life cycle to achieve earlier flowering, fruiting, or seed production, which can be beneficial in agriculture and horticulture.
3. Improving Reproduction is established by increasing the plant's ability to produce seeds, fruits, or other reproductive structures, which is crucial for plant propagation and agriculture.
4. Enhancing Root Development established by focusing on root growth to improve nutrient and water uptake, which can have a significant impact on overall plant health and productivity.
5. Optimizing Flowering and Fruit Set established by manipulating factors like light, temperature, and nutrients to encourage more prolific flowering and higher fruit or seed production.

The term “bud system” refers to the growth and development of the buds on a plant. Buds are small, undeveloped shoots that have the potential to grow into leaves, flowers, or new branches.

The term “flower system” refers to the growth and development, quantity, quality, and overall performance of flowers on a plant.

The term “vigor” refers to the process of improving the overall strength, health, and vitality of a plant and consequently leads to an increase in crop yields, better plant resilience, and improved overall plant health.

The term “integrated pest management (IPM)” refers to an approach to pest control that combines various methods to minimize the impact of pests on crops while emphasizing the use of environmentally friendly and sustainable practices. The goal of IPM is to manage pests effectively while minimizing risks to human health and the environment.

is

As used herein the term “prolonged effect” means obtaining insecticidal activity over an extended period after the application of one or more insecticides for controlling insect infestation of the plant or locus over an extended period, before and/or after an infestation or before and/or after insect damage are shown and/or when the insect pressure is low/high. Insect pressure may be assessed based on the conditions associated with insect development such as population density and certain environmental conditions.

As used herein, the phrase “agriculturally acceptable carrier” means carriers that are known and accepted in the art for the formation of compositions for agricultural or horticultural use. Such agriculturally acceptable carriers can be, but not limited to, water, organic oil, clay, granules, aerosol, microencapsulated material, and fertilizer.

As used herein the term “pesticide” refers to any substance or mixture of substances intended for preventing, destroying, repelling, or mitigating pests, such as insecticide and fungicide.

As used herein, the term “insecticide” broadly refers to compounds that kill, control, repel, or mitigate one or more species of insects. For chemical classes and applications, as well as specific compounds of each class, see “The Pesticide Manual Thirteenth Edition” (British Crop Protection Council, Hampshire, U K, 2003), as well as “The e-Pesticide Manual, Version 3” (British Crop Protection Council, Hampshire, U K, 2003-04), the contents of each of which are incorporated herein by reference in their entirety.

As used herein the term “plant” or “crop” refers, but is not limited to whole plants, plant organs (e.g., leaves, stems, twigs, roots, trunks, limbs, shoots, fruits), plant cells, or plant seeds. This term also encompasses plant crops such as oilseed rape (e.g. canola), cotton, rice, banana, potato (including sweet potato), coffee, sugar cane, citrus, beans, sunflower, corn, soybean, wheat, barley, oats, chickpeas, fruit trees, nut trees (e.g. almonds), lentils, grain sorghum, alfalfa, brassicas, fruiting vegetables (e.g. tomatoes, pepper, chili, eggplant, cucumber, squash), tea, bulb vegetables (e.g. onion, leek), grapes, pome fruit (e.g. apples, pears), and stone fruit (e.g. pears, plums). In some embodiments, the term “plant” may include the propagation material thereof.

As used herein the term “plant propagation material” refers, but is not limited to, all the generative parts of the plant such as seeds and vegetative plant material such as cuttings and tubers, which can be used for the multiplication of the plant including tubers, spores, corms, bulbs, rhizomes, sprouts basal shoots, stolons, and buds and other parts of plants, including seedlings and young plants, which are to be transplanted after germination or after emergence from soil.

The term “locus” as used herein refers not only to areas where the pest such as an insecticide may already be developed, but also to areas that have not yet been attacked by a said pest, and to areas under cultivation. Locus includes the crop and propagation material of the crop (all the generative parts of the crop such as seeds and vegetative plant material such as cuttings and tubers, which can be used for the multiplication of the plant. Examples of propagation material of the crop include seeds, tubers, spores, corms, bulbs, rhizomes, sprouts basal shoots, stolons, buds, and other parts of plants, including seedlings and young plants, which could be transplanted after germination or after emergence from soil. Locus also includes the area surrounding the crop and the growing media of the crop, such as soil and crop fields.

As used herein, the term “treating a plant or a locus against insect and/or mite pest” includes, but is not limited to, protecting the plant or locus against insect and/or mite pest and/or controlling insect and/or mite pest of the plant or locus.

As used herein, the terms “control” or “controlling” are meant to include, but are not limited to, any killing, growth-regulating, inhibiting, or interfering with the normal life cycle of the pest activities of a given pest. These terms include for example preventing larvae from developing into mature insects, modulating the emergence of pests from eggs including preventing eclosion, degrading the egg material, suffocation, reducing gut motility, inhibiting the formation of chitin, disrupting mating or sexual communication, and preventing feeding activity.

As used herein, the terms “protect” or “protecting” are meant to include, but are not limited to, any blocking, restricting, limiting, securing, or barring the presence of the insect and/or mite pest.

As used herein the term “ha” refers to hectare.

As used herein the term “METI” refers to mitochondrial complex I electron transport inhibitors.

As used herein, the term “Aphis gossypii” refers to, but is not limited to, insects of the aphid's family of Aphididae, “Aphidoidea”. Other names include, but are not limited to, cotton aphid, melon aphid, melon and cotton aphid.

As used herein, the term “thrips” refers, but is not limited to, to insects of the slender family of Thysanoptera. Other names include, but is not limited to, “Physopoda”.

### The Agrochemical Composition Subject of Invention:

The present invention provides an insecticidal mixture comprising a) a bioactive agent selected from garlic extract, garlic oil, and the mixture thereof; and b) additional insecticide selected from the group consisting of neonicotinoids, pyrethroids, pyropenes, diamides, benzoylureas, METI acaricides and insecticides, mesoionics, pyridine azomethine derivatives, tetronic and tetramic acid derivatives, phenylpyrazoles, flonicamid, benzpyrimoxan, sulfoxaflor, and the mixtures thereof.

According to an embodiment, the bioactive agent selected from garlic extract, garlic oil, and the mixture thereof a) comprising at least one compound selected from the group comprising diallyl thiosulfonate (allicin), allyl methyl sulfide, diallyl sulfide (DAS), diallyl disulfide (DADS), diallyl trisulfide (DATS), diallyl tetra-sulfide, E/Z-ajoene, S-allyl-cysteine (SAC), S-allyl-cysteine sulfoxide (alliin), propionaldehyde, dipropyl disulfide, citral, geraniol, linalool, α and β-phellandrene, caffeic acid, ferulic acid, and the mixtures thereof.

According to an embodiment, the bioactive agent selected from garlic extract, garlic oil, and the mixture thereof a) comprising at least one compound selected from the group comprising diallyl thiosulfonate (allicin), allyl methyl sulfide, diallyl sulfide (DAS), diallyl disulfide (DADS), diallyl trisulfide (DATS), diallyl tetra-sulfide, E/Z-ajoene, S-allyl-cysteine (SAC), S-allyl-cysteine sulfoxide (alliin), propionaldehyde, dipropyl disulfide.

According to an embodiment, the bioactive agent selected from garlic extract, garlic oil, and the mixture thereof a) comprising at least one compound selected from the group comprising diallyl thiosulfonate (allicin), allyl methyl sulfide, diallyl sulfide (DAS), diallyl disulfide (DADS), diallyl trisulfide (DATS).

According to an embodiment, the bioactive agent selected from garlic extract, garlic oil, and the mixture thereof a) comprising at least one compound selected from the group comprising diallyl sulfide (DAS), diallyl disulfide (DADS), diallyl trisulfide (DATS).

According to an embodiment, the bioactive agent selected from garlic extract, garlic oil, and the mixture thereof a) comprising at least one compound selected from the group comprising diallyl disulfide (DADS), diallyl trisulfide (DATS).

According to an embodiment, the amount of the diallyl sulfide (DAS) is from 1% to 30% by weight, based on the weight of total bioactive agent selected from garlic extract, garlic oil, and the mixture thereof a), more preferably from 5% to 25% by weight, based on the weight of total bioactive agent selected from garlic extract, garlic oil, and the mixture thereof a), most preferably from 10% to 20% by weight, based on the weight of total bioactive agent selected from garlic extract, garlic oil, and the mixture thereof a).

According to an embodiment, the amount of the diallyl sulfide (DAS) is from 30% to 40% by weight, based on the weight of total bioactive agent selected from garlic extract, garlic oil, and the mixture thereof a).

According to an embodiment, the amount of the diallyl sulfide (DAS) is from 20% to 30% by weight, based on the weight of total bioactive agent selected from garlic extract, garlic oil, and the mixture thereof a).

According to an embodiment, the amount of the diallyl sulfide (DAS) is from 10% to 20% by weight, based on the weight of total bioactive agent selected from garlic extract, garlic oil, and the mixture thereof a).

According to an embodiment, the amount of the diallyl disulfide (DADS) is from 1% to 70% by weight, based on the weight of total bioactive agent selected from garlic extract, garlic oil, and the mixture thereof a), more preferably from 5% to 60% by weight, based on the weight of total bioactive agent selected from garlic extract, garlic oil, and the mixture thereof a), most preferably from 10% to 30% by weight, based on the weight of total bioactive agent selected from garlic extract, garlic oil, and the mixture thereof a).

According to an embodiment, the amount of the diallyl disulfide (DADS) is from 55% to 65% by weight, based on the weight of total bioactive agent selected from garlic extract, garlic oil, and the mixture thereof a).

According to an embodiment, the amount of the diallyl disulfide (DADS) is from 45% to 55% by weight, based on the weight of total bioactive agent selected from garlic extract, garlic oil, and the mixture thereof a).

According to an embodiment, the amount of the diallyl disulfide (DADS) is from 35% to 45% by weight, based on the weight of total bioactive agent selected from garlic extract, garlic oil, and the mixture thereof a).

According to an embodiment, the amount of the diallyl disulfide (DADS) is from 25% to 35% by weight, based on the weight of total bioactive agent selected from garlic extract, garlic oil, and the mixture thereof a).

According to an embodiment, the amount of the diallyl disulfide (DADS) is from 15% to 25% by weight, based on the weight of total bioactive agent selected from garlic extract, garlic oil, and the mixture thereof a).

According to an embodiment, the amount of the diallyl disulfide (DATS) is from 1% to 40% by weight, based on the weight of total bioactive agent selected from garlic extract, garlic oil, and the mixture thereof a), more preferably from 5% to 30% by weight, based on the weight of total bioactive agent selected from garlic extract, garlic oil, and the mixture thereof a), most preferably from 10% to 25% by weight, based on the weight of total bioactive agent selected from garlic extract, garlic oil, and the mixture thereof a).

According to an embodiment, the amount of the diallyl disulfide (DATS) is from 15% to 25% by weight, based on the weight of total bioactive agent selected from garlic extract, garlic oil, and the mixture thereof a).

According to an embodiment, the amount of the diallyl disulfide (DATS) is from 5% to 15% by weight, based on the weight of total bioactive agent selected from garlic extract, garlic oil, and the mixture thereof a).

According to an embodiment, the bioactive agent selected from garlic extract, garlic oil, and the mixture thereof is produced by the solvent extraction process, wherein the origin garlic is mixed with water, and the active compounds are isolated through distillation.

According to an embodiment, the bioactive agent selected from garlic extract, garlic oil, and the mixture thereof is produced by solvent extraction process, wherein the origin garlic is mixed with alcohol solvent and the active compounds are isolated through distillation.

According to another embodiment, the bioactive agent selected from garlic extract, garlic oil, and the mixture thereof is produced by the separation of the juice of the garlic from its solid parts, by applying mechanical pressure and filtration.

According to another embodiment, garlic oil can be produced via steam distillation of garlic extracts to obtain cleaner mixtures of allyl/methyl mixed polysulfides.

According to an embodiment, an increase of certain ingredients i.e., diallyl disulfide or diallyl trisulfide, in the final formulation may occur artificially after the completion of the process above to boost biological performance which may vary between different batches.

Garlic extract is available as a commercial product, for example, Bralic® (ADAMA), or could be prepared according to the methods described in Soteyome, T. et. Al, “Preparation and processing of garlic extract and its further application on anti-fungal activity” Journal of Survey in Fisheries Sciences 10(2S) 2021-2035, 2023.

Garlic oil is available as a commercial product BioRepel or could be prepared according to the methods described in Stanway, P. (2012). “The Miracle of Garlic: Practical Tips for Health & Home” Watkins Media. p. 25. Retrieved Dec. 29, 2017.

Garlic juice is available as a commercial product Garlic Barrier® or could be prepared according to the methods described in Trivedi A., “Antimicrobial activity of fresh garlic juice: An in vitro study” AYU (An International Quarterly Journal of Research in Ayurveda) April-June; 36(2): 203-207, 2015.

According to an embodiment, the additional insecticide b) is neonicotinoid selected from the group consisting of: acetamiprid, clothianidin, dinotefuran, imidacloprid, nitenpyram, thiacloprid, thiamethoxam, and the mixtures thereof.

According to an embodiment, the additional insecticide b) is neonicotinoid selected from the group consisting of: acetamiprid, imidacloprid, and the mixtures thereof.

According to an embodiment, the additional insecticide b) is acetamiprid.

According to an embodiment, additional insecticide b) is pyrethroid selected from the group consisting of: acrinathrin, allethrin, d-cis-trans allethrin, d-trans allethrin, bifenthrin, bioallethrin, s-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate flucythrinate, flumethrin, tau-fluvalinate, halfenprox, imiprothrin, kadethrin, permethrin, phenothrin, prallethrin, pyrethrins, pyrethrum, resmethrin, silafluofen, tefluthrin, tetramethrin, tralomethrin, transfluthrin, and the mixtures thereof.

According to an embodiment, additional insecticide b) is pyrethroid selected from the group consisting of: bifenthrin, lambda-cyhalothrin, tau-fluvalinate, and the mixtures thereof.

According to an embodiment, additional insecticide b) is bifenthrin.

According to an embodiment, additional insecticide b) is lambda-cyhalothrin.

According to an embodiment, additional insecticide b) is tau-fluvalinate.

According to an embodiment, additional insecticide b) is diamide selected from the group consisting of: chlorantraniliprole, cyantraniliprole, cyclaniliprole, flubendiamide, tetraniliprole, and the mixtures thereof.

According to an embodiment, additional insecticide b) is diamide selected from the group consisting of: chlorantraniliprole, cyantraniliprole, cyclaniliprole, and the mixtures thereof.

According to an embodiment, additional insecticide b) is benzoylurea selected from the group consisting of: bistrifluron, chlorfluazuron, diflubenzuron, flucycloxuron, flufenoxuron, hexaflumuron, lufenuron, novaluron, noviflumuron, teflubenzuron, triflumuron, and the mixtures thereof.

According to an embodiment, additional insecticide b) is METI acaricide or METI insecticide selected from the group consisting of: fenazaquin, fenpyroximate, pyridaben, pyrimidifen, tebufenpyrad, tolfenpyrad, and the mixtures thereof.

According to an embodiment, additional insecticide b) is tolfenpyrad.

According to an embodiment, additional insecticide b) is mesoionic selected from the group consisting of: triflumezopyrim, dicloromezotiaz, and the mixtures thereof.

According to an embodiment, additional insecticide b) is pyridine azomethine derivative, selected from the group consisting of: pymetrozine, pyrifluquinazon, and the mixtures thereof.

According to an embodiment, additional insecticide b) is pymetrozine.

According to an embodiment, additional insecticide b) is pyrifluquinazon.

According to an embodiment, additional insecticide b) is tetronic and tetramic acid derivative selected from the group consisting of: spirodiclofen, spiromesifen, spiropidion, spirotetramat and the mixtures thereof.

According to an embodiment, additional insecticide b) is spirotetramat.

According to an embodiment, additional insecticide b) is phenylpyrazole selected from the group consisting of: ethiprole, fipronil and the mixtures thereof.

According to an embodiment, additional insecticide b) is fipronil.

According to an embodiment, additional insecticide b) is selected from the group comprising benzpyrimoxan, azadirachtin, afidopyropen, diafenthiuron, flonicamid, and the mixtures thereof.

According to an embodiment, additional insecticide b) is azadirachtin.

According to an embodiment, additional insecticide b) is benzpyrimoxan.

According to an embodiment, additional insecticide b) is diafenthiuron.

According to an embodiment, additional insecticide b) is afidopyropen.

According to an embodiment, additional insecticide b) is flonicamid.

According to an embodiment, the weight ratio of the bioactive agent selected from garlic extract, garlic oil, and the mixture thereof a) to the additional insecticide b) is from 100:1 to 1:100, 50:1 to 1:50, 25:1 to 1:25, 10:1 to 1:10, 5:1 to 1:5, 2:1 to 1:2.

According to an embodiment, the weight ratio of the bioactive agent selected from garlic extract, garlic oil, and the mixture thereof a) to the additional insecticide b) is from 10:1 to 1:10, 5:1 to 1:5, 2:1 to 1:2.

According to an embodiment, the weight ratio of the bioactive agent selected from garlic extract, garlic oil, and the mixture thereof a) to the additional insecticide b) is from 10:1 to 1:10.

According to an embodiment, the weight ratio of the bioactive agent selected from garlic extract, garlic oil, and the mixture thereof a) to the additional insecticide b) is from 5:1 to 1:5.

According to an embodiment, the weight ratio of the bioactive agent selected from garlic extract, garlic oil, and the mixture thereof a) to the additional insecticide b) is from 2:1 to 1:2.

According to an embodiment, the weight ratio of the bioactive agent selected from garlic extract, garlic oil, and the mixture thereof a) to the additional insecticide b) is 100:1, 50:1, 25:1, 20:1, 10:1, 5:1, 2:1, 1:1, 1:2, 1:5, 1:10, 1:20, 1:25, 1:50, 1:100.

According to an embodiment, the weight ratio of the bioactive agent selected from garlic extract, garlic oil, and the mixture thereof a) to the additional insecticide b) is 10:1, 7:1, 5:1, 3:1, 2:1, 1:1, 1:2, 1:3, 1:5, 1:7, 1:10.

According to an embodiment, the weight ratio of the bioactive agent selected from garlic extract, garlic oil, and the mixture thereof a) to the additional insecticide b) is 10:1, 5:1, 2:1, 1:1, 1:2, 1:5, 1:10.

According to an embodiment, the weight ratio of the bioactive agent selected from garlic extract, garlic oil, and the mixture thereof a) to the additional insecticide b) is 10:1.

According to an embodiment, the weight ratio of the bioactive agent selected from garlic extract, garlic oil, and the mixture thereof a) to the additional insecticide b) is 1:10.

According to an embodiment, the weight ratio of the bioactive agent selected from garlic extract, garlic oil, and the mixture thereof a) to the additional insecticide b) is 5:1.

According to an embodiment, the weight ratio of the bioactive agent selected from garlic extract, garlic oil, and the mixture thereof a) to the additional insecticide b) is 1:5.

According to an embodiment, the weight ratio of the bioactive agent selected from garlic extract, garlic oil, and the mixture thereof a) to the additional insecticide b) is 2:1.

According to an embodiment, the weight ratio of the bioactive agent selected from garlic extract, garlic oil, and the mixture thereof a) to the additional insecticide b) is 1:2.

According to an embodiment, the weight ratio of the bioactive agent selected from garlic extract, garlic oil, and the mixture thereof a) to the additional insecticide b) is 1:1.

According to an embodiment, the weight ratio of the bioactive agent selected from garlic extract, garlic oil, and the mixture thereof a) to azadirachtin is 1:2, more preferably is 1:1.

According to an embodiment, the weight ratio of the bioactive agent selected from garlic extract, garlic oil, and the mixture thereof a) to lambda-cyhalothrin is 1:1, more preferably is 2:1, most preferably is 1:2.

According to an embodiment, the weight ratio of the bioactive agent selected from garlic extract, garlic oil, and the mixture thereof a) to benzpyrimoxan is 1:5, more preferably is 1:2, most preferably is 1:1.

According to an embodiment, the weight ratio of the bioactive agent selected from garlic extract, garlic oil, and the mixture thereof a) to fipronil is 10:1, most preferably is 1:1.

According to an embodiment, the weight ratio of the bioactive agent selected from garlic extract, garlic oil, and the mixture thereof a) to tolfenpyrad is 1:10, most preferably is 1:1.

According to an embodiment, the weight ratio of the bioactive agent selected from garlic extract, garlic oil, and the mixture thereof a) to spirotetramat is 1:2, more preferably is 1:1, most preferably is 2:1.

According to an embodiment, the weight ratio of the bioactive agent selected from garlic extract, garlic oil, and the mixture thereof a) to acetamiprid is 1:1, more preferably is 1:10, most preferably is 10:1.

According to an embodiment, the weight ratio of the bioactive agent selected from garlic extract, garlic oil, and the mixture thereof a) to pyrifluquinazon is 1:10, most preferably is 10:1.

According to an embodiment, the weight ratio of the bioactive agent selected from garlic extract, garlic oil, and the mixture thereof a) to tau-fluvalinate is 1:2.

According to an embodiment, the weight ratio of the bioactive agent selected from garlic extract, garlic oil, and the mixture thereof a) to diafenthiuron is 1:5.

According to an embodiment, the weight ratio of the bioactive agent selected from garlic extract, garlic oil, and the mixture thereof a) to afidopyropen is 1:100.

According to an embodiment, the weight ratio of the bioactive agent selected from garlic extract, garlic oil, and the mixture thereof a) to afidopyropen is 2:1.

According to an embodiment, the amount of the bioactive agent selected from garlic extract, garlic oil, and the mixture thereof a) is from 0.01% to 99% by weight, based on the weight of total mixture.

According to an embodiment, the amount of the bioactive agent selected from garlic extract, garlic oil, and the mixture thereof a) is from 0.1% to 70% by weight, based on the weight of total mixture.

According to an embodiment, the amount of the bioactive agent selected from garlic extract, garlic oil, and the mixture thereof a) is from 1% to 50% by weight, based on the weight of total mixture.

According to an embodiment, the amount of the bioactive agent selected from garlic extract, garlic oil, and the mixture thereof a) is from 1% to 10% by weight, based on the weight of total mixture.

According to an embodiment, the amount of the additional insecticide b) is from 0.01% to 70% by weight, based on the weight of total mixture.

According to an embodiment, the amount of the additional insecticide b) is from 0.1% to 70% by weight, based on the weight of total mixture.

According to an embodiment, the amount of the additional insecticide b) is from 1% to 70% by weight, based on the weight of total mixture.

According to an embodiment, the amount of the additional insecticide b) is from 10% to 70% by weight, based on the weight of total mixture.

According to an embodiment, the amount of the additional insecticide b) is from 30% to 70% by weight, based on the weight of total mixture.

According to an embodiment, the amount of the additional insecticide b) is from 40% to 60% by weight, based on the weight of total mixture.

According to an embodiment, the amount of the additional insecticide b) is from 5% to 50% by weight, based on the weight of total mixture.

In yet another embodiment, the insecticidal mixture may be applied in various mixtures or combinations. For example, in a pre-mixed concentrate form, in a single “ready-for-use” form, or a combined mixture, composed from separate formulations of the single pesticide, such as a “tank-mix” form.

In an embodiment, the insecticidal mixture is applied in the form of a “ready-for-use” formulation comprising the bioactive agent selected from garlic extract, garlic oil, and the mixture thereof a) and the additional insecticide b). This formulation can be obtained by combining the insecticides in an effective amount with an agriculturally acceptable carrier, a surfactant or other application-promoting adjuvant customarily employed in formulation technology.

In an embodiment, the insecticidal mixture is applied in the form of a pre-mixed concentrate formulation comprising the bioactive agent selected from garlic extract, garlic oil, and the mixture thereof a) and the additional insecticide b). This formulation can be obtained by combining the insecticides in an effective amount with an agriculturally acceptable carrier, a surfactant or other application-promoting adjuvant customarily employed in formulation technology.

According to an embodiment, the insecticidal mixture is formulated as a solid formulation selected from the group comprising dust (DP), granule (GR), pellet (PS), wettable powder (WP), water dispersible granule (WG), water dispersible tablet (WT), water soluble granule (WSG), water-soluble powder (WSP), bait (B), granular bait (GB), microencapsulated (M), tablet.

According to an embodiment, the insecticidal mixture can be provided as common liquid formulation selected from and not limited to water dispersible granules (WDG), soluble powder (SP), suspension concentrate (SC), soluble concentrate (SL), suspoemulsion (SE), oil-in-water emulsion (EW), emulsion concentrated (EC), microencapsulated formulation, dispersible concentrate (DC), oil dispersion (OD), ULV (ultra-low-volume) liquid formulations, Gel. These formulation types could be prepared according to procedures known in the art.

According to an embodiment, the insecticidal mixture can be provided as common formulation selected from and not limited to suspension concentrate (SC), suspoemulsion (SE), oil-in-water emulsion (EW), emulsion concentrated (EC), microencapsulated formulation. These formulation types could be prepared according to procedures known in the art.

According to an embodiment, the insecticidal mixture comprising at least one additional component selected from the group of surfactants, solid diluents, and liquid diluents, and the mixture thereof.

According to an embodiment, the total sum amount of the bioactive agent selected from garlic extract, garlic oil, and the mixture thereof a) and the additional insecticide b) in the insecticidal mixture is from 0.1 to 99 wt. %, from 0.1 to 95 wt. %, or from 0.1 to 90 wt. %, based on the total weight of the insecticidal mixture. The remaining components in the formulation are for example carrier and additives.

According to an embodiment, the total sum amount of the bioactive agent selected from garlic extract, garlic oil, and the mixture thereof a) and the additional insecticide b) in the insecticidal mixture is from 1 to 70 wt. %, based on the total weight of the insecticidal mixture. The remaining components in the formulation are for example carrier and additives.

According to an embodiment, the total sum amount of the bioactive agent selected from garlic extract, garlic oil, and the mixture thereof a) and the additional insecticide b) in the insecticidal mixture is from 1 to 50 wt. %, based on the total weight of the insecticidal mixture. The remaining components in the formulation are for example carrier and additives.

According to an embodiment, the total sum amount of the bioactive agent selected from garlic extract, garlic oil, and the mixture thereof a) and the additional insecticide b) in the insecticidal mixture is from 1 to 40 wt. %, based on the total weight of the insecticidal mixture. The remaining components in the formulation are for example carrier and additives.

According to an embodiment, the total sum amount of the bioactive agent selected from garlic extract, garlic oil, and the mixture thereof a) and the additional insecticide b) in the insecticidal mixture is from 1 to 30 wt. %, based on the total weight of the insecticidal mixture. The remaining components in the formulation are for example carrier and additives. The remaining components in the formulation are for example carrier and additives.

According to an embodiment, the total sum amount of the bioactive agent selected from garlic extract, garlic oil, and the mixture thereof a) and the additional insecticide b) in the insecticidal mixture is from 1 to 20 wt. %, based on the total weight of the insecticidal mixture. The remaining components in the formulation are for example carrier and additives.

According to an embodiment, the total sum amount of the bioactive agent selected from garlic extract, garlic oil, and the mixture thereof a) and the additional insecticide b) in the insecticidal mixture is from 1 to 10 wt. %, based on the total weight of the insecticidal mixture. The remaining components in the formulation are for example carrier and additives.

According to an embodiment, the total amount of the bioactive agent selected from garlic extract, garlic oil, and the mixture thereof a) and the additional insecticide b) in the insecticidal mixture is from 1%, 2%, 5%, 7%, 10% to 90%, 93%, 95%, 98%, 99% based on the total weight of the insecticidal mixture. The remaining components in the formulation are for example carrier and additives.

According to an embodiment, the total sum amount of the bioactive agent selected from garlic extract, garlic oil, and the mixture thereof a) and the additional insecticide b) in the insecticidal mixture is 1%, 3%, 5%, 7%, 10%, based on the total weight of the insecticidal mixture. The remaining components in the formulation are for example carrier and additives.

According to an embodiment, the total sum amount of the bioactive agent selected from garlic extract, garlic oil, and the mixture thereof a) and the additional insecticide b) in the insecticidal mixture is 20%, 30%, 40%, 50%, 60%, 70% based on the total weight of the insecticidal mixture. The remaining components in the formulation are for example carrier and additives.

According to an embodiment, the insecticidal mixture of the present invention may include additional crop protection agent, for example insecticides, herbicides, fungicides, bactericides, nematicides, molluscicides, growth regulators, biological agents, fertilizers, or mixtures thereof.

According to an embodiment, the insecticidal mixture of the present invention is diluted prior to application in enough water.

According to an embodiment, the insecticidal mixture of the present invention is diluted prior to application in enough water, and the pH of the water solution is stabilized to between 5 to 8, more preferably between 5.5 to 7, most preferably between 6 to 6.5.

Another aspect of this invention comprises a method for controlling pests comprising treating the infested crop with an effective amount of the present insecticidal mixture.

According to an embodiment, the infested crop treated with the present insecticidal mixture, for the controlling of pests, is selected from the group comprising alfalfa almonds, apples, avocado, barley, beans, beet, berries, blackberry, brassicas, broccoli, cabbage, carrots, cauliflower, cherries, chili clover, chickpea seeds, coffee, corn, cotton, cucumbers, cucurbits, grapefruits kiwi, lemons, lettuce, limes, maize, melon, mushrooms, oil seed rape, olive, onions, oranges, ornamentals such as roses pasture, peaches, peanuts, pears, peas, peppers, peppermint, pineapples, plums, pome and stone fruits, potatoes, pumpkin, rice, sorghum, soybean, spinach, sugar cane, sunflower, sweat potato, table and wine grapes, tobacco, tomatoes, tree nuts, walnuts, watermelon, wheat and yucca.

According to an embodiment, the infested crop treated with the present insecticidal mixture, for the controlling of pests, is selected from vegetables.

According to an embodiment, the infested crop treated with the insecticidal mixture, for controlling pests, is from the group comprising pepper, cotton, soybean, and corn.

According to an embodiment, the infested crop treated with the present insecticidal mixture, for the controlling pests, is pepper.

According to an embodiment, the infested crop treated with the present insecticidal mixture, for the controlling pests, is cotton.

According to an embodiment, the infested crop treated with the present insecticidal mixture, for the controlling pests, is soybean.

According to an embodiment, the infested crop treated with the present insecticidal mixture, for the controlling pests, is grapes.

Another aspect of this invention comprises a method for protecting crops from pest infestation comprising treating the crop with an effective amount of the present insecticidal mixture in the absence of insecticidal pressure on said crop.

According to an embodiment, the crop protected with the present insecticidal mixture in the absence of insecticidal pressure, is selected from the group comprising alfalfa almonds, apples, avocado, barley, beans, beet, berries, blackberry, brassicas, broccoli, cabbage, carrots, cauliflower, cherries, chili clover, chickpea seeds, coffee, corn, cotton, cucumbers, cucurbits, grapefruits kiwi, lemons, lettuce, limes, maize, melon, mushrooms, oil seed rape, olive, onions, oranges, ornamentals such as roses pasture, peaches, peanuts, pears, peas, peppers, peppermint, pineapples, plums, pome and stone fruits, potatoes, pumpkin, rice, sorghum, soybean, spinach, sugar cane, sunflower, sweat potato, table and wine grapes, tobacco, tomatoes, tree nuts, walnuts, watermelon, wheat and yucca.

According to an embodiment, the crop protected with the present insecticidal mixture in the absence of insecticidal pressure, is selected from vegetables.

According to an embodiment, the crop protected with the present insecticidal mixture in the absence of insecticidal pressure, is selected from the group comprising pepper, cotton, soybean, and corn.

According to an embodiment, the crop protected with the insecticidal mixture in the absence of insecticidal pressure, is pepper.

According to an embodiment, the crop protected with the insecticidal mixture in the absence of insecticidal pressure, is cotton.

According to an embodiment, the crop protected with the present insecticidal mixture in the absence of insecticidal pressure, is soybean.

According to an embodiment, the crop protected with the present insecticidal mixture in the absence of insecticidal pressure, is grapes.

The present invention also relates to a method for controlling pests by contacting the pests or their food supply, habitat, breeding grounds, their locus with a synergistically effective amount of the mixture according to the present invention.

The present invention provides a method for controlling pests by contacting the pests or their food supply, habitat, breeding grounds or their locus with an effective amount of the insecticidal mixture according to the present invention, so as to thereby control insects.

The present invention provides a method of protecting plants from attack or infestation by pests comprising contacting the plant, or the soil or water in which the plant is growing, with an effective amount of the insecticidal mixture according to the present invention, to thereby protecting plants from attack or infestation by said pests.

According to an embodiment, the target pests are selected from the group comprising ants, aphids, armyworms, beetles, caterpillars, chinch bugs, grasshoppers, fruit borers, leafhoppers, leafminers, leafrollers loopers, maggots, mealybugs, mites, nematodes, psyllids, rust flies, sawflies, scales, slugs, thrips, tubeworms, whiteflies, white grubs, wireworms, webworms, and weevils.

According to an embodiment, the target pests are selected from the Coleoptera order such as Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp, Cerotoma spp. (chrysomeids), Cerotoma trifurcata (bean leaf beetle), Ceutorhynchus spp. (weevils), Ceutorhynchus assimilis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys futscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha (common European cockchafer), Oberea brevis, Oberea linearis, Oryctes rhinoceros (date palm beetle), Oryzaephilus mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (Eurpoean chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle) and Zabrus tenebioides.

According to an embodiment, the target insect pests are selected from Diptera order, such as Aedes spp. (mosquitoes), Agromyza frontella (alfalfa blotch leafminer), Agromyza spp. (leaf miner flies), Anastrepha spp. (fruit flies), Anastrepha suspensa (Caribbean fruit fly), Anopheles spp. (mosquitoes), Batrocera spp. (fruit flies), Bactrocera cucurbitae (melon fly), Bactrocera dorsalis (oriental fruit fly), Ceratitis spp. (fruit flies), Ceratitis capitata (Mediterranea fruit fly), Chrysops spp. (deer flies), Cocliliomyia spp. (screwworms), Contarinia spp. (Gall midges), Culex spp. (mosquitoes), Dasineura spp. (gall midges), Dasineura brassicae (cabbage gall midge), Delia spp., Delia platura (seedcorn maggot), Drosophila spp. (vinegar flies), Fannia spp. (filth flies), Fannia canicularis (little house fly), Fannia scalaris (latrine fly), Gasterophilus intestinalis (horse bot fly), Gracillia perseae, Haematobia irritans (horn fly), Hylemyia spp. (root maggots), Hypoderma lineatum (common cattle grub), Liriomyza spp. (leafminer flies), Liriomyza brassica (serpentine leafminer), Melophagus ovinus (sheep ked), Musca spp. (muscid flies), Musca autumnalis (face fly), Musca domestica (house fly), Oestrus ovis (sheep bot fly), Oscinella frit (grass fly), Pegomyia betae (beet leafminer), Phorbia spp., Psila rosae (carrot rust fly), Rhagoletis cerasi (cherry fruit fly), Rhagoletis pomonella (apple maggot), Sitodiplosis mosellana (orange wheat blossom midge), Stomoxys calcitrans (stable fly), Tabanus spp. (horse flies) and Tipula spp. (crane flies).

According to an embodiment, the target insect pests are selected from Hemiptera order, such as Acrosternum hilare (green stink bug), Blissus leucopterus (chinch bug), Calocoris norvegicus (potato mirid), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus hesperus (western tarnished plant bug), Maconellicoccus hirsutus, Neurocolpus longirostris, Nezara viridula (southern green stink bug), Paratrioza cockerelli, Phytocoris spp. (plant bugs), Phytocoris californicus, Phytocoris relativus, Piezodorus guildingi, Poecilocapsus lineatus (fourlined plant bug), Psallus vaccinicola, Pseudacysta perseae, Scaptocoris castanea and Triatoma spp. (bloodsucking conenose bugs/kissing bugs).

According to an embodiment, the target insect pests are selected from Homoptera order, such as Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella, Aphrophora spp. (leafhoppers), Aonidiella aurantii (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale) and Zulia entreriana.

According to an embodiment, the target insect pests are selected from Lepidoptera order, such as Achoea janata, Adoxophyes spp., Adoxophyes orana, Agrotis spp. (cutworms), Agrotis ipsilon (black cutworm), Alabama argillacea (cotton leafworm), Amorbia cuneana, Amyelosis transitella (navel orangeworm), Anacamptodes defectaria, Anarsia lineatella (peach twig borer), Anomis sabulifera (jute looper), Anticarsia gemmatalis (velvetbean caterpillar), Spodoptera frugiperda (all armyworm caterpillar), Archips argyrospila (fruittree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leafperforator), Caloptilia spp. (leaf miners), Capua reticulana, Carposina niponensis (peach fruit moth), Chilo spp., Chlumetia transversa (mango shoot borer), Choristoneura rosaceana (obliquebanded leafroller), Chrysodeixis spp., Cnaphalocerus medinalis (grass leafroller), Colias spp., Conpomorpha cramerella, Cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraea graniosella (southwester corn borer), Earias spp. (bollworms), Earias insulata (Egyptian bollworm), Earias vitella (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobbaco moth), Ephestia kuehniella (Mediterranean flour moth), Epimeces spp., Epinotia aporema, Erionota thrax (banana skipper), Eupoecilia ambiguella (grape berry moth), Euxod auxiliaris (army cutworm), Feltia spp. (cutworms), Gortyna spp. (stemborers), Grapholita molesta (oriental fruit moth), Hedylepta indicata (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparana (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leafminers), Pieris rapae (imported cabbageworm), Plathypena scabra, Plodia interpunctella (Indian meal moth), Plutella xylostella (diamondback moth), Polychrosis viteana (grape berry moth), Prays endocarpa, Prays oleae (olive moth), Pseudaletia spp. (noctuid moths), Pseudaletia unipunctata (armyworm), Pseudoplusia includens (soybean looper), Rachiplusia nu, Scirpophaga incertulas, Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera fugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer) and Zeuzera pyrina (leopard moth).

According to an embodiment, the target insect pests are selected from Orthoptera order, such as Anabrus simplex (Mormon cricket), Gryllotalpidae (mole crickets), Locusta migratoria, Melanoplus spp. (grasshoppers), Microcentrum retinerve (angularwinged katydid), Pterophylla spp. (kaydids), Chistocerca gregaria, Scudderia furcata (forktailed bush katydid) and Valanga nigricorni.

According to an embodiment, the target insect pests are selected from Thysanoptera order, such as Frankliniella fusca (tobacco thrips), Caliothrips brasiliensis (soybean thrips), Frankliniella occidentalis (western flower thrips), Frankliniella shultzei, Frankliniella schultzei, Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis and Thrips spp.

According to an embodiment, the target insect pests are selected from Acari order, such as spider mites (family Tetranychidae), thread-footed mites (family Tarsonemidae), and the gall mites (family Eriophyidae).

According to an embodiment, the target insect pests are selected from Nematodes, such as Aphelenchoides (foliar nematodes), Bursaphelenchus xylophilus, Ditylenchus, Globodera (potato cyst nematodes), Heterodera (soybean cyst nematodes), Longidorus, Meloidogyne (root-knot nematodes), Nacobbus, Pratylenchus (lesion nematodes), Trichodorus, and Xiphinema (dagger nematodes)

According to an embodiment, the target insect pest is selected from Aphis gossypii (cotton aphid), thrips, mites, and leafhoppers (Cicadidae).

According to an embodiment, the present invention provides a method for controlling Aphis gossypii in cotton.

According to an embodiment, the present invention provides a method for controlling Aphis gossypii in pepper.

According to an embodiment, the present invention provides a method of using the insecticidal mixture for protecting cotton crop from Aphis gossypii.

According to an embodiment, the present invention provides a method for protecting pepper crop from Aphis gossypii.

According to an embodiment, the application rate of the insecticidal mixture according to the present invention is from 1 g/ha to 1000 g/ha, more preferable from 1 g/ha to 100 g/ha, most preferable from 10 g/ha to 50 g/ha.

According to an embodiment, the application rate of the insecticidal mixture according to the present invention is 1000 g/ha.

According to an embodiment, the application rate of the insecticidal mixture according to the present invention is 500 g/ha.

According to an embodiment, the application rate of the insecticidal mixture according to the present invention is 100 g/ha.

According to an embodiment, the application rate of the insecticidal mixture according to the present invention is 50 g/ha.

According to an embodiment, the application rate of the insecticidal mixture according to the present invention is 30 g/ha.

According to an embodiment, the application of the mixture according to the present invention is preferably applied early in the day or during sunset, in times of low heat and solar radiation.

In another embodiment, the insecticidal mixture of the present invention may be applied pre-sowing or post-sowing, pre-emergence, or early post-emergence of the crop. The insecticidal mixture may be applied via furrow spray, foliar application, broadcast, basal application, soil application, soil incorporation, or soil injection where the crop is growing.

This present invention also comprises the use of the insecticidal mixture according to the present invention, wherein a synergistic mixture of the bioactive agent selected from garlic extract, garlic oil, and the mixture thereof a) and additional insecticide b) is applied to the crop or to the locus wherein the crop is growing.

According to an embodiment, the insecticidal mixture according to the present invention establishes a synergistic effect.

For purpose of the present invention, a synergistic effect refers to the condition, in which the overall activity of the insecticidal mixture comprising bioactive agent selected from garlic extract, garlic oil, and the mixture thereof a) and an additional insecticide b) is greater than the sum of the activities of each one of the insecticides alone.

According to an embodiment, the insecticidal mixture of the present invention shows synergistic effect when the bioactive agent selected from garlic extract, garlic oil, and the mixture thereof a) and the additional insecticide b) are taken in a synergistically effective amount.

According to an embodiment, an amount of the bioactive agent selected from garlic extract, garlic oil, and the mixture thereof a) and an amount of the additional insecticide b) if applied together are more effective than when bioactive agent selected from garlic extract, garlic oil, and the mixture thereof a) at the same amount, and the insecticide b) at the same amount, is applied alone.

According to an embodiment, an amount of the bioactive agent selected from garlic extract, garlic oil, and the mixture thereof a) and an amount of the additional insecticide b) in a ratio of between 10:1 to 1:10, if applied together are more effective than when bioactive agent selected from garlic extract, garlic oil, and the mixture thereof a) at the same amount, and the additional insecticide b) at the same amount, is applied alone.

According to an embodiment, an amount of the bioactive agent selected from garlic extract, garlic oil, and the mixture thereof a) and an amount of the additional insecticide b) in a ratio of between 5:1 to 1:5, if applied together are more effective than when the bioactive agent selected from garlic extract, garlic oil, and the mixture thereof a) at the same amount, and the additional insecticide b) at the same amount, is applied alone.

According to an embodiment, an amount of the bioactive agent selected from garlic extract, garlic oil, and the mixture thereof a) and an amount of the additional insecticide b) in a ratio of between 2:1 to 1:2, if applied together are more effective than when the bioactive agent selected from garlic extract, garlic oil, and the mixture thereof a) at the same amount, and the additional insecticide b) at the same amount, is applied alone.

According to an embodiment, an amount of the bioactive agent selected from garlic extract, garlic oil, and the mixture thereof a) and an amount of the additional insecticide b) in a ratio of 10:1, 5:1, 2:1, 1:1, 1:2, 1:5, and 1:10 if applied together are more effective than when the bioactive agent selected from garlic extract, garlic oil, and the mixture thereof a) at the same amount, and the additional insecticide b) at the same amount, is applied alone.

According to an embodiment, the insecticidal mixture is an improved combination in that the amount of the additional insecticide b) is effective to increase sensitivity of the insect to the amount of the bioactive agent selected from garlic extract, garlic oil, and the mixture thereof a) compared to the sensitivity of the insect to the amount of the bioactive agent selected from garlic extract, garlic oil, and the mixture thereof a) when it is applied not in combination with the amount of the additional insecticide b).

According to an embodiment, the insecticidal mixture is an improved combination in that it prolonged the period of protection against insect infection and/or control of insect infection than when the amount of the bioactive agent selected from garlic extract, garlic oil, and the mixture thereof a) and the amount the additional insecticide b) of are applied alone.

According to an embodiment, the amount of bioactive agent selected from garlic extract, garlic oil, and the mixture thereof a) needed to achieve a level of insect control in the presence of the additional insecticide b) is reduced, compared to the amount of bioactive agent selected from garlic extract, garlic oil, and the mixture thereof a) when applied alone.

According to an embodiment, the insecticidal mixture according to the present invention is an improved combination in that it reduces the amount of time needed to achieve a level of insect control compared to when the amount of the bioactive agent selected from garlic extract, garlic oil, and the mixture thereof a) and the amount of the additional insecticide b) are applied alone.

According to an embodiment, the insecticidal mixture of garlic extract, garlic oil, and the mixture thereof a) and azadirachtin in a ratio of 1:2 is synergistic.

According to an embodiment, the insecticidal mixture of garlic extract, garlic oil, and the mixture thereof a) and azadirachtin in a ratio of 1:1 is synergistic.

According to an embodiment, the insecticidal mixture of garlic extract, garlic oil, and the mixture thereof a) and lambda-cyhalothrin in a ratio of 1:2 is synergistic.

According to an embodiment, the insecticidal mixture of garlic extract, garlic oil, and the mixture thereof a) and lambda-cyhalothrin in a ratio of 1:1 is synergistic.

According to an embodiment, the insecticidal mixture of garlic extract, garlic oil, and the mixture thereof a) and lambda-cyhalothrin in a ratio of 2:1 is synergistic.

According to an embodiment, the insecticidal mixture of garlic extract, garlic oil, and the mixture thereof a) and benzpyrimoxan in a ratio of 1:5 is synergistic.

According to an embodiment, the insecticidal mixture of garlic extract, garlic oil, and the mixture thereof a) and benzpyrimoxan in a ratio of 1:1 is synergistic.

According to an embodiment, the insecticidal mixture of garlic extract, garlic oil, and the mixture thereof a) and benzpyrimoxan in a ratio of 5:1 is synergistic.

According to an embodiment, the insecticidal mixture of garlic extract, garlic oil, and the mixture thereof a) and fipronil in a ratio of 1:1 is synergistic.

According to an embodiment, the insecticidal mixture of garlic extract, garlic oil, and the mixture thereof a) and tolfenpyrad in a ratio of 1:1 is synergistic.

According to an embodiment, the insecticidal mixture of garlic extract, garlic oil, and the mixture thereof a) and spirotetramat in a ratio of 2:1 is synergistic.

According to an embodiment, the insecticidal mixture of garlic extract, garlic oil, and the mixture thereof a) and acetamiprid in a ratio of 1:10 is synergistic.

According to an embodiment, the insecticidal mixture of garlic extract, garlic oil, and the mixture thereof a) and acetamiprid in a ratio of 10:1 is synergistic.

According to an embodiment, the insecticidal mixture of garlic extract, garlic oil, and the mixture thereof a) and pyrifluquinazon in a ratio of 1:10 is synergistic.

According to an embodiment, the insecticidal mixture of garlic extract, garlic oil, and the mixture thereof a) and pyrifluquinazon in a ratio of 10:1 is synergistic.

Another aspect of this invention comprising the use of the insecticidal mixture according to the present invention for improvement of the health of a plant.

The present invention provides a method for improvement of the health of a plant by enhancing plant growth comprising applying an effective amount of any one of the insecticidal mixtures according to the present invention and/or compositions disclosed herein to one or more plants, the locus thereof or propagation material thereof.

The present invention provides a method for improvement of the health of a plant by enhancing crop plants development and/or enhancing crop plants vigor and/or improving plant potential yield comprising applying an effective amount of the any one of the insecticidal mixtures according to the present invention or the compositions disclosed herein to one or more plants, the locus thereof or propagation material thereof.

The present invention provides a method for improvement of the health of a plant by enhancing plant development comprising applying an effective amount of the any one of insecticidal mixtures according to the present invention or the compositions disclosed herein to one or more plants, the locus thereof or propagation material thereof so as to thereby enhance plant development.

The present invention provides a method for improvement of the health of a plant by enhancing buds system comprising applying an effective amount of the any one of the insecticidal mixtures according to the present invention or the compositions disclosed herein to one or more plants, the locus thereof or propagation material thereof so as to thereby enhance the buds system.

The present invention provides a method for improvement of the health of a plant by enhancing flower system comprising applying an effective amount of the any one of the insecticidal mixtures according to the present invention or the compositions disclosed herein to one or more plants, the locus thereof or propagation material thereof so as to thereby enhance the flower system.

The present invention provides a method for improvement of the health of a plant by enhancing plant vigor comprising applying an effective amount of the any one of the insecticidal mixtures according to the present invention or the compositions disclosed herein to one or more plants, the locus thereof or propagation material thereof so as to thereby enhance plant vigor.

The present invention provides a method for improvement of the health of a plant by enhancing knock-down activity and/or prolonged control comprising contacting the plant, or the soil or water in which the plant is growing, with an effective amount of the any one of the insecticidal mixtures according to the present invention or the compositions disclosed herein so as to thereby enhance knock-down activity and/or prolonged control.

According to an embodiment, the insecticidal mixtures according to the present invention are applied as a knock-down treatment.

According to an embodiment, the insecticidal mixtures according to the present invention are applied to provide prolonged insecticidal control.

The present invention provides a method for regulating plant growth comprising applying an effective amount of the insecticidal mixtures according to the present invention or the compositions disclosed herein to one or more plants, the locus thereof, or propagation material thereof to thereby regulate plant growth.

The present invention provides a method for improving plant potential yield comprising applying an effective amount of the any one of the insecticidal mixtures according to the present invention or the compositions disclosed herein to one or more plants, the locus thereof or propagation material thereof to thereby improve plant potential yield.

According to an embodiment, the use of the insecticidal mixture according to the present invention or the compositions disclosed herein increases the yield of the crop by at least 5%.

According to an embodiment, the use of the insecticidal mixture according to the present invention or the compositions disclosed herein increases the yield of the crop by at least 10%.

According to an embodiment, the use of the insecticidal mixture according to the present invention or the compositions disclosed herein increases the yield of the crop by at least 20%.

According to an embodiment, the use of the insecticidal mixture according to the present invention or the compositions disclosed herein increases the yield of the crop by at least 25%.

In some embodiments, the insecticidal mixture according to the present invention are improved combinations in which the amount of the bioactive agent selected from garlic extract, garlic oil, and the mixture thereof a) and the additional insecticide b) is effective for treating a plant or locus against fungal infection.

In another embodiment, the bioactive agent selected from garlic extract, garlic oil, and the mixture thereof a) and the additional insecticide b) can be applied simultaneously, that is jointly or separately, or in succession, the sequence, in the case of separate application, generally not having any effect on the result of the control measures.

That is, the bioactive agent selected from garlic extract, garlic oil, and the mixture thereof a) and additional insecticide b) may be applied jointly or in succession. In an embodiment, the bioactive agent selected from garlic extract, garlic oil, and the mixture thereof a) and the additional insecticide b) can be prepared separately as individual formulations, and the individual formulations are applied as is, or diluted to predetermined concentrations.

In another embodiment, the bioactive agent selected from garlic extract, garlic oil, and the mixture thereof a), and the additional insecticide b) can be prepared separately, as individual formulations, and the individual formulations can be mixed together, when diluted to a predetermined concentration.

In another embodiment, the bioactive agent selected from garlic extract, garlic oil, and the mixture thereof a) and additional insecticide b) can be formulated together, and the formulation is applied as it is, or the formulation is diluted to a predetermined concentration.

### Experimental Part:

The following examples illustrate the practice of the present invention in some of its embodiments but should not be construed as limiting the scope of the invention. Other embodiments will be apparent to one skilled in the art from consideration of the specification and examples. It is intended that the specifications, including the examples, is considered exemplary only without limiting the scope and spirit of the invention.

### Example 1—Efficacy of Insecticidal Mixtures of Garlic Extract and Different Insecticides on Aphis gossypii in Pepper Plant

### Objectives:

Evaluating the synergistic or antagonistic effects of garlic extract and other insecticides on Aphis gossypii in pepper crop.

### Description of Field Trial (Study Procedures):

### Plant and Insects

Pepper plants of Makko F1 cv, obtained from seeds, were grown at totally controlled conditions in a growing chamber. Healthy and untreated Pepper plants were used at least two months after seeding to get leaf disks suitable to be exposed to Aphis gossypii adults.

The aphids' adults were obtained from mass rearing; aphids were reared on cucumber and zucchini plants under controlled environmental conditions.

### Method

Suitable leaves were collected from pepper plants. Leaf disks were prepared together with arenas containing a layer of water agar on the base. 8 leaf disks per treatment were obtained from the collected leaves and 20 adults/arena were inoculated.

Each arena was sprayed, using an electric low pressure hand sprayer, with the corresponding insecticide mixture. Tween 80 surfactant, at the rate of 0.05% was added in each treatment mixture.

The untreated check was sprayed with distilled water together with Tween 80 surfactant at a dose of 0.05%.

The experimental arenas were kept in a growth chamber under controlled climatic conditions: 21° C. (±0.5), 60% RH and 16:8 light:dark photoperiod regime. The assessment of mortality (as % of died adults+progeny) was performed according to the characteristics of each Active Ingredient.

Garlic extract a) and the additional pesticide b) were priorly calibrated to obtain the Dose Response Curve and the Lethal Dose (ppm) values; according to the calibrations the mixing protocols were obtained at the proper mixing ratios.

All the statistical procedures [Student-Newman-Keuls (SNK), Dose response analysis (Probit, confidence level 95%) Anova and other calculation analysis] were performed using the ARM 2020.0 software.

### Synergy/Antagonism Assessment

The evaluation of Synergy or Antagonism of the two active ingredients was performed by using the Colby's formula, above described:

$$E = A + B - ( \frac{AB}{100} )$$

in which E represents the expected percentage of insecticidal control for the combination of the two insecticides at defined doses, A is the percentage of insecticidal control observed by the compound (I) at a defined dose (for example, a), B is the percentage of insecticidal control observed by the compound (II) at a defined dose (for example, b). When the ratio between the observed percentage of insecticidal control for the combination of the two insecticides at defined doses and the expected percentage of insecticidal control for the combination of the two insecticides at defined doses is greater than 1.15, the effect is synergistic.

### Materials:

TABLE 1
Insecticides that were used in the present trial.

| | | | Insecticide | | Conc. | Specific |
|---|---|---|---|---|---|---|
| | Product (P) | Source | (AI) | Type | g/L | gravity |
| 1 | Bralic ®1.8 | ADAMA | Garlic extract | EC | 18 | 0.94 |
| 2 | EPIK SL ® | SIPCAM | Acetamiprid | SL | 50 | 1.076 |
| 3 | VERSYS ® | BASF | Afidopyropen | SC | 100 | 1.02 |
| 4 | OIKOS ® | SIPCAM | Azadirachtin | EC | 26 | 1.085 |
| 5 | ORCHESTRA ® | NICHINO | benzpyrimoxan | SC | 10.6 | 1.076 |
| 6 | PEGASUS ® | SYNGENTA | Diafenthiuron | L | 500 | 1.05 |
| 7 | AGADI ® | ADAMA | Fipronil | SC | 5 | 1.06 |
| 8 | TEPPEKI ® | BELCHIM | Flonicamid | WG | 50 | n.a |
| 9 | KARATE ZEON ® | SYNGENTA | Lambda cyhalothrin | L | 15 | 1.02 |
| 10 | RYCAR ® | SEPRO | Pyrifluquinazon | SC | 200 | 1.12 |
| 11 | MOVENTO ® | BAYER | Spirotetramat | SC | 48 | 1.09 |
| 12 | MAVRIK SMART ® | ADAMA | Tau fluvalinate | EW | 240 | 1.09 |
| 13 | TOLFENPYRAD 15 ® | NIHON NOHYAKU | Tolfenpyrad | EC | 150 | 1.01 |

TABLE 2
Summary of the Synergy assessment (synergy/antagonism) evaluation of
garlic extract insecticidal mixtures on Aphis gossypii. (The active
material appeared in the table are used as displayed in table 1)

| | ratio | | ratio | Synergy | ratio | Synergy |
|---|---|---|---|---|---|---|
| active | antagonism/ | Synergy | antagonism/ | assessment | antagonism/ | assessment |
| ingredient | synergism | assessment | synergism | [%] | synergism | [%] |
| azadirachtin | ratio 1:2 | 1.79 | ratio 1:1 | 2.26 | ratio 2:1 | 0.58 |
| | synergy | | synergy | | antagonism | |
| lambda- | ratio 1:2 | 1.82 | ratio 1:1 | 1.65 | ratio 2:1 | 1.85 |
| cyhalothrin | synergy | | synergy | | synergy | |
| benzpyrimoxan | ratio 1:5 | 1.21 | ratio 1:1 | 1.38 | ratio 5:1 | 1.58 |
| | synergy | | synergy | | synergy | |
| fipronil | ratio 1:10 | 0.52 | ratio 1:1 | 1.39 | ratio 10:1 | 1.09 |
| | antagonism | | synergy | | additive | |
| tolfenpyrad | ratio 1:10 | 1.08 | ratio 1:1 | 1.17 | ratio 10:1 | 0.90 |
| | additive | | synergy | | antagonism | |
| spirotetramat | ratio 1:2 | 1.06 | ratio 1:1 | 1.06 | ratio 2:1 | 1.15 |
| | additive | | additive | | synergy | |
| acetamiprid | ratio 1:10 | 1.98 | ratio 1:1 | 1.03 | ratio 10:1 | 2.08 |
| | synergy | | additive | | synergy | |
| pyrifluquinazon | ratio 1:10 | 1.40 | ratio 1:1 | 0.98 | ratio 10:1 | 1.86 |
| | synergy | | antagonism | | synergy | |
| tau-fluvalinate | ratio 1:2 | 0.64 | ratio 1:1 | 0.52 | ratio 2:1 | 1.11 |
| | antagonism | | antagonism | | additive | |
| diafenthiuron | ratio 1:5 | 1.12 | ratio 1:1 | 0.34 | ratio 5:1 | 0.66 |
| | additive | | antagonism | | antagonism | |
| afidopyropen | ratio 1:100 | 1.00 | ratio 1:1 | 0.47 | ratio 100:1 | 0.13 |
| | additive | | antagonism | | antagonism | |
| flonicamid | ratio 1:2 | 0.83 | ratio 1:1 | 0.32 | ratio 2:1 | 1.03 |
| | antagonism | | antagonism | | additive | |

* Synergy assessment - the ratio between the observed percentage of insecticidal control for the combination of the two insecticides at defined doses and the expected percentage of insecticidal control for the combination of the two insecticides at defined doses.

### Results and Discussion:

The field trials showed that the mortality rate of Aphis gossypii adults on pepper plants varied depending on the mixtures they were exposed to. The tested garlic extract mixtures showed both synergistic and antagonistic effects at different levels. The highest synergistic effect of 2.26 was obtained for the mixture of garlic extract with azadirachtin mixture at a ratio of 1:1. The azadirachtin mixture also led to the high synergistic effect of 1.79 at a ratio of 1:2. Interestingly, when altering the ratio to 2:1, the synergistic effect revers and the mixture led to antagonism result of 0.58. A relatively high synergistic effect of 1.98 and 2.08 was observed for the mixtures of garlic extract with acetamiprid at a ratio of 1:10 and 10:1, respectively. A high synergistic effect of 1.82 and 1.85 was also observed for the mixtures of garlic extract with lambda-cyhalothrin at a ratio of 1:2 and 2:1, respectively. The mixtures of garlic extract with lambda-cyhalothrin and the mixtures of garlic extract with benzpyrimoxan exhibited synergistic effects in all tested ratios. The mixture of garlic extract with pyrifluquinazon also showed a modest synergistic effect of about 1.40 and about 1.86 at a ratio of 1:10 and 10:1, respectively. Antagonistic effects of between 1.0 to 1.12 were observed for the mixtures of garlic extract with tolfenpyrad at a ratio of 1:10 and spirotetramat at a ratio of 1:2 and 1:1, and with the mixtures of garlic extract with tau-fluvalinate at a ratio of 2:1, diafenthiuron at a ratio of 1:12, afidopyropen at a ratio of 1:100 and flonicamid at a ratio of 2:1.

### CONCLUSIONS

The use of garlic extract mixtures on Aphis gossypii on pepper the plant led to a decrease in the Aphis gossypii adult population. The effect of the mixture is, surprisingly, synergistic when applying certain ratios. One can emphasize the potential of these mixtures in different untested ratios, other insects, and other insecticide combinations with garlic extract, which lead to an even higher synergistic effect. This trial result demonstrates a new opportunity to reduce synthetic insecticide use and increase the use of natural pesticides.

### Supporting Data:

TABLE 3
Mortality results and synergy/antagonism evaluation
of Garlic extract & Acetamiprid insecticidal mixture.

| | Garlic | | Mortality | Mortality | Synergy |
|---|---|---|---|---|---|
| | extract | Acetamiprid | Observed | Expected | assessment |
| Ratio | [ppm ai] | [ppm ai] | [%] | [%] | [%] |
| 1:10 | 0.01 | 0.1 | 73.7 | 37.15 | 1.98 |
| | 0.01 | — | −23 | | (synergy) |
| | — | 0.01 | 48.9 | | |
| 1:1 | 0.1 | 0.1 | 51.7 | 50.075 | 1.03 |
| | 0.1 | — | 2.3 | | (Additive) |
| | — | 0.1 | 48.9 | | |
| 10:1 | 0.5 | 0.05 | 71.2 | 34.225 | 2.08 |
| | 0.5 | — | 12.3 | | (synergy) |
| | — | 0.05 | 25 | | |

TABLE 4
Mortality results and synergy/antagonism evaluation of
Garlic extract & Afidopyropen insecticidal mixture.

| | Garlic | Afido- | Mortality | Mortality | Synergy |
|---|---|---|---|---|---|
| | extract | pyropen | Observed | Expected | assessment |
| Ratio | [ppm ai] | [ppm ai] | [%] | [%] | [%] |
| 1:100 | 0.01 | 1 | 29.6 | 29.46 | 1.00 |
| | 0.01 | — | −12.5 | | (additive) |
| | — | 1 | 37.3 | | |
| 1:1 | 2 | 2 | 30.2 | 64.78 | 0.47 |
| | 2 | — | 30.4 | | (antagonism) |
| | — | 2 | 49.4 | | |
| 100:1 | 2 | 0.02 | 6.2 | 48.01 | 0.13 |
| | 2 | — | 30.4 | | (antagonism) |
| | — | 0.02 | 25.3 | | |

TABLE 5
Mortality results and synergy/antagonism evaluation of
Garlic extract & Azadirachtin insecticidal mixture.

| | Garlic | | Mortality | Mortality | Synergy |
|---|---|---|---|---|---|
| | extract | Azadirachtin | Observed | Expected | assessment |
| Ratio | [ppm ai] | [ppm ai] | [%] | [%] | [%] |
| 1:2 | 1 | 2 | 71.2 | 39.71 | 1.79 |
| | 1 | — | 15.2 | | (synergy) |
| | — | 2 | 28.9 | | |
| 1:1 | 1 | 1 | 77.8 | 34.45 | 2.26 |
| | 1 | — | 15.2 | | (synergy) |
| | — | 1 | 22.7 | | |
| 2:1 | 2 | 1 | 22.1 | 38.01 | 0.58 |
| | 2 | — | 19.8 | | (antagonism) |
| | — | 1 | 22.7 | | |

TABLE 6
Mortality results and synergy/antagonism evaluation of
Garlic extract & Benzpyrimoxan insecticidal mixture.

| | Garlic | | Mortality | Mortality | Synergy |
|---|---|---|---|---|---|
| | extract | Benzpyrimoxan | Observed | Expected | assessment |
| Ratio | [ppm ai] | [ppm ai] | [%] | [%] | [%] |
| 1:5 | 1 | 5 | 70.2 | 58.07 | 1.21 |
| | 1 | — | 27.7 | | (synergy) |
| | — | 5 | 42 | | |
| 1:1 | 5 | 5 | 82 | 59.63 | 1.38 |
| | 5 | — | 30.4 | | (synergy) |
| | — | 5 | 42 | | |
| 5:1 | 4 | 0.8 | 49.7 | 31.52 | 1.58 |
| | 4 | — | 25.4 | | (synergy) |
| | — | 0.8 | 8.2 | | |

TABLE 7
Mortality results and synergy/antagonism evaluation of
Garlic extract & Diafenthiuron insecticidal mixture.

| | Garlic | | Mortality | Mortality | Synergy |
|---|---|---|---|---|---|
| | extract | Diafenthiuron | Observed | Expected | assessment |
| Ratio | [ppm ai] | [ppm ai] | [%] | [%] | [%] |
| 1:5 | 1 | 5 | 43.29 | 38.76 | 1.12 |
| | 1 | — | 17.2 | | (additive) |
| | — | 5 | 26.04 | | |
| 1:1 | 5 | 5 | 17.2 | 50.63 | 0.34 |
| | 5 | — | 33.09 | | (antagonism) |
| | — | 5 | 26.22 | | |
| 5:1 | 5 | 1 | 31.64 | 48.25 | 0.66 |
| | 5 | — | 33.09 | | (antagonism) |
| | — | 1 | 22.66 | | |

TABLE 8
Mortality results and synergy/antagonism evaluation
of Garlic extract & Fipronil insecticidal mixture.

| | Garlic | | Mortality | Mortality | Synergy |
|---|---|---|---|---|---|
| | extract | Fipronil | Observed | Expected | assessment |
| Ratio | [ppm ai] | [ppm ai] | [%] | [%] | [%] |
| 1:10 | 0.05 | 0.5 | 27.3 | 52.06 | 0.52 |
| | 0.05 | — | 15.6 | | (antagonism) |
| | — | 0.5 | 43.2 | | |
| 1:1 | 0.1 | 0.1 | 62.2 | 44.62 | 1.39 |
| | 0.1 | — | 14.8 | | (synergy) |
| | — | 0.1 | 35 | | |
| 10:1 | 1 | 0.1 | 55.7 | 51.12 | 1.09 |
| | 1 | — | 24.8 | | (additive) |
| | — | 0.1 | 35 | | |

TABLE 9
Mortality results and synergy/antagonism evaluation
of Garlic extract & Flonicamid insecticidal mixture.

| | Garlic | | Mortality | Mortality | Synergy |
|---|---|---|---|---|---|
| | extract | Flonicamid | Observed | Expected | assessment |
| Ratio | [ppm ai] | [ppm ai] | [%] | [%] | [%] |
| 1:2 | 1 | 2 | 39.7 | 47.58 | 0.83 |
| | 1 | — | 28 | | (antagonism) |
| | — | 2 | 27.2 | | |
| 1:1 | 1 | 1 | 16 | 50.61 | 0.32 |
| | 1 | — | 28 | | (antagonism) |
| | — | 1 | 31.4 | | |
| 2:1 | 2 | 1 | 52.4 | 50.68 | 1.03 |
| | 2 | — | 28.1 | | (additive) |
| | — | 1 | 31.4 | | |

TABLE 10
Mortality results and synergy/antagonism evaluation of Garlic
extract & Lambda cyhalothrin insecticidal mixture.

| | Garlic | Lambda | Mortality | Mortality | Synergy |
|---|---|---|---|---|---|
| | extract | cyhalothrin | Observed | Expected | assessment |
| Ratio | [ppm ai] | [ppm ai] | [%] | [%] | [%] |
| 1:2 | 0.2 | 0.4 | 75 | 41.16 | 1.82 |
| | 0.2 | — | 5.7 | | (synergy) |
| | — | 0.4 | 37.6 | | |
| 1:1 | 0.4 | 0.4 | 77.9 | 47.21 | 1.65 |
| | 0.4 | — | 15.4 | | (synergy) |
| | — | 0.4 | 37.6 | | |
| 2:1 | 0.4 | 0.2 | 78.9 | 42.56 | 1.85 |
| | 0.4 | — | 15.4 | | (synergy) |
| | — | 0.2 | 32.1 | | |

TABLE 11
Mortality results and synergy/antagonism evaluation of
Garlic extract & Pyrifluquinazon insecticidal mixture.

| | Garlic | Pyriflu- | Mortality | Mortality | Synergy |
|---|---|---|---|---|---|
| | extract | quinazon | Observed | Expected | assessment |
| Ratio | [ppm ai] | [ppm ai] | [%] | [%] | [%] |
| 1:10 | 0.05 | 0.5 | 62.9 | 44.88 | 1.40 |
| | 0.05 | — | 3.8 | | (synergy) |
| | — | 0.5 | 42.7 | | |
| 1:1 | 0.8 | 0.8 | 55.5 | 56.82 | 0.98 |
| | 0.8 | — | 17.6 | | (Antagonism) |
| | — | 0.8 | 47.6 | | |
| 10:1 | 0.8 | 0.08 | 70.9 | 38.12 | 1.86 |
| | 0.8 | — | 17.6 | | (synergy) |
| | — | 0.08 | 24.9 | | |

TABLE 12
Mortality results and synergy/antagonism evaluation of
Garlic extract & Spirotetramat insecticidal mixture.

| | Garlic | | Mortality | Mortality | Synergy |
|---|---|---|---|---|---|
| | extract | Spirotetramat | Observed | Expected | assessment |
| Ratio | [ppm ai] | [ppm ai] | [%] | [%] | [%] |
| 1:2 | 1 | 2 | 61.6 | 57.91 | 1.06 |
| | 1 | — | 24.3 | | (additive) |
| | — | 2 | 44.4 | | |
| 1:1 | 2 | 2 | 65 | 61.30 | 1.06 |
| | 2 | — | 30.4 | | (additive) |
| | — | 2 | 44.4 | | |
| 2:1 | 2 | 1 | 53.9 | 46.76 | 1.15 |
| | 2 | — | 30.4 | | (synergy) |
| | — | 1 | 23.5 | | |

TABLE 13
Mortality results and synergy/antagonism evaluation of
Garlic extract & Tau fluvalinate insecticidal mixture.

| | Garlic | Tau | Mortality | Mortality | Synergy |
|---|---|---|---|---|---|
| | extract | fluvalinate | Observed | Expected | assessment |
| Ratio | [ppm ai] | [ppm ai] | [%] | [%] | [%] |
| 1:2 | 0.1 | 0.2 | 31 | 48.26 | 0.64 |
| | 0.1 | — | 0.7 | | (Antagonism) |
| | — | 0.2 | 47.9 | | |
| 1:1 | 0.2 | 0.2 | 27 | 52.33 | 0.52 |
| | 0.2 | — | 8.5 | | (Antagonism) |
| | — | 0.2 | 47.9 | | |
| 2:1 | 0.2 | 0.1 | 38 | 34.21 | 1.11 |
| | 0.2 | — | 8.5 | | (additive) |
| | — | 0.1 | 28.1 | | |

TABLE 14
Mortality results and synergy/antagonism evaluation
of Garlic extract & Tolfenpyrad insecticidal mixture.

| | Garlic | | Mortality | Mortality | Synergy |
|---|---|---|---|---|---|
| | extract | Tolfenpyrad | Observed | Expected | assessment |
| Ratio | [ppm ai] | [ppm ai] | [%] | [%] | [%] |
| 1:10 | 0.1 | 1 | 47.3 | 43.73 | 1.08 |
| | 0.1 | — | 7.3 | | (additive) |
| | — | 1 | 39.3 | | |
| 1:1 | 0.2 | 0.2 | 34.3 | 29.27 | 1.17 |
| | 0.2 | — | 15.9 | | (additive) |
| | — | 0.2 | 15.9 | | |
| 10:1 | 2 | 0.2 | 32.9 | 36.67 | 0.90 |
| | 2 | — | 24.7 | | (Antagonism) |
| | — | 0.2 | 15.9 | | |

1. An insecticidal mixture comprising a) a bioactive agent selected from garlic extract, garlic oil, and the mixture thereof; and b) an additional insecticide selected from the group consisting of neonicotinoids, pyrethroids, pyropenes, diamides, benzoylureas, METI acaricides and insecticides, mesoionics, pyridine azomethine derivatives, tetronic and tetramic acid derivatives, phenylpyrazoles, flonicamid, benzpyrimoxan, sulfoxaflor and the mixtures thereof.

2. The insecticidal mixture according to claim 1, wherein the bioactive agent selected from garlic extract, garlic oil, and the mixture thereof a) comprises at least one compound c) selected from diallyl thiosulfonate (allicin), allyl methyl sulfide, diallyl sulfide (DAS), diallyl disulfide (DADS), diallyl trisulfide (DATS), diallyl tetrasulfide, E/Z-ajoene, S-allyl-cysteine (SAC), S-allyl-cysteine sulfoxide (alliin), propionaldehyde, dipropyl disulfide.

3. The insecticidal mixture according to any of claims 1-2, wherein the additional insecticide b) is neonicotinoid selected from the group consisting of: acetamiprid, clothianidin, dinotefuran, imidacloprid, nitenpyram, thiacloprid, thiamethoxam, and the mixtures thereof.

4. The insecticidal mixture according to any of claims 1-2, wherein the additional insecticide b) is pyrethroid selected from the group consisting of: acrinathrin, allethrin, d-cis-trans allethrin, d-trans allethrin, bifenthrin, bioallethrin, s-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate flucythrinate, flumethrin, tau-fluvalinate, halfenprox, imiprothrin, kadethrin, permethrin, phenothrin, prallethrin, pyrethrins, pyrethrum, resmethrin, silafluofen, tefluthrin, tetramethrin, tetramethrin, tralomethrin, transfluthrin, and the mixtures thereof.

5. The insecticidal mixture according to claim 4, wherein the additional insecticide b) is pyrethroid selected from the group consisting of: bifenthrin, lambda-cyhalothrin, tau-fluvalinate, and the mixtures thereof.

6. The insecticidal mixture according to any of claims 1-2, wherein the additional insecticide b) is diamide selected from the group consisting of: chlorantraniliprole, cyantraniliprole, cyclaniliprole, flubendiamide, tetraniliprole and the mixtures thereof.

7. The insecticidal mixture according to any of claims 1-2, wherein the additional insecticide b) is benzoylurea selected from the group consisting of: bistrifluron, chlorfluazuron, diflubenzuron, flucycloxuron, flufenoxuron, hexaflumuron, lufenuron, novaluron, noviflumuron, teflubenzuron, triflumuron and the mixtures thereof.

8. The insecticidal mixture according to any of claims 1-2, wherein the additional insecticide b) is METI acaricide or METI insecticide selected from the group consisting of: fenazaquin, fenpyroximate, pyridaben, pyrimidifen, tebufenpyrad, tolfenpyrad, and the mixtures thereof.

9. The insecticidal mixture according to any of claims 1-2, wherein the additional insecticide b) is mesoionic selected from the group consisting of: triflumezopyrim, dicloromezotiaz, and the mixtures thereof.

10. The insecticidal mixture according to any of claims 1-2, wherein the additional insecticide b) is pyridine azomethine derivative, selected from the group consisting of: pymetrozine, pyrifluquinazon, and the mixtures thereof.

11. The insecticidal mixture according to any of claims 1-2, wherein the additional insecticide b) is tetronic or tetramic acid derivative selected from the group consisting of: spirodiclofen, spiromesifen, spiropidion, spirotetramat and the mixtures thereof.

12. The insecticidal mixture according to any of claims 1-2, wherein the additional insecticide b) is phenylpyrazole selected from the group consisting of: ethiprole, fipronil and the mixtures thereof.

13. The insecticidal mixture according to any of claims 1-12, wherein the additional insecticide b) is selected from the group consisting of: benzpyrimoxan, acetamiprid, azadirachtin, afidopyropen, tolfenpyrad, diafenthiuron, fipronil, pyrifluquinazon, spirotetramat, flonicamid, lambda-cyhalothrin, tau-fluvalinate, and the mixtures thereof.

14. The insecticidal mixture according to any of claim 13, wherein the additional insecticide b) is tau-fluvalinate.

15. The insecticidal mixture according to any of claims 1-14, wherein the weight ratio of the bioactive agent selected from garlic extract, garlic oil, and the mixture thereof a) to the additional insecticide b) is from 100:1 to 1:100.

16. The insecticidal mixture according to any of claims 1-15, wherein the amount of the bioactive agent selected from garlic extract, garlic oil, and the mixture thereof a) is from 0.01% to 99.0% by weight, based on the weight of total mixture.

17. The insecticidal mixture according to any of claims 1-16, wherein the amount of the additional insecticide b) is from 0.01% to 70.0% by weight, based on the weight of total mixture.

18. The insecticidal mixture according to any of claims 1-17, initiates a synergistic effect.

19. The insecticidal mixture according to claim 18, wherein the additional insecticide b) is tau-fluvalinate.

20. The insecticidal mixture according to any of claims 1-19, formulated as a solid formulation selected from the group consisting of: dust (DP), granule (GR), pellet (PS), wettable powder (WP), water dispersible granule (WG), water dispersible tablet (WT), water soluble granule (WSG), water-soluble powder (WSP), granular bait (GB).

21. The insecticidal mixture according to any of claims 1-19, formulated as a liquid formulation selected from the group consisting of suspension concentrate (SC), soluble concentrate (SL), suspoemulsion (SE), emulsion (EW), emulsion concentrated (EC), microencapsulate, dispersible concentrate (DC), oil dispersion (OD), ULV formulations.

22. A method for controlling pests comprising treating the infested crop with an effective amount of the insecticidal mixture according to any of the preceding claims 1-21.

23. The method for controlling pests according to claim 22, wherein the crop is alfalfa almonds, apples, avocado, barley, beans, beet, berries, blackberry, brassicas, broccoli, cabbage, carrots, cauliflower, cherries, chili clover, chickpea seeds, coffee, corn, cotton, cucumbers, cucurbits, grapefruits kiwi, lemons, lettuce, limes, maize, melon, mushrooms, oil seed rape, olive, onions, oranges, ornamentals such as roses pasture, peaches, peanuts, pears, peas, peppers, peppermint, pineapples, plums, pome and stone fruits, potatoes, pumpkin, rice, sorghum, soybean, spinach, sugar cane, sunflower, sweat potato, table and wine grapes, tobacco, tomatoes, tree nuts, walnuts, watermelon, wheat and yucca.

24. The method for controlling pests according to any of claims 22-23, wherein the crop is brassicas, cotton, cucurbits, peppers, pineapples, grapes, and tomatoes.

25. The method for controlling pests according to any of claims 22-24, wherein the pest is ants, aphids, armyworms, beetles, caterpillars, chinch bugs, grasshoppers, fruit borers, leafhoppers, leafminers, leafrollers loopers, maggots, mealybug, mites, nematodes, psyllids, rust flies, sawflies, scales, slugs, thrips, tubeworms, whiteflies, white grubs, wireworms, webworms, weevils.

26. The method for controlling pests according to any of claim 22-25, wherein the pest is at least one of Aphis gossypii, Myzus persicae, Thrips tabaci, Frankliniela occidentalis, Empoasca vitis, Tetranychus urticae, and Bemisia tabaci.

27. A method for protecting crop from pests' infestation comprising treating the crop with an effective amount of the insecticidal mixture according to any of the preceding claims 1-21.

28. The method for protecting crop according to claim 27, wherein the crop is alfalfa almonds, apples, avocado, barley, beans, beet, berries, blackberry, brassicas, broccoli, cabbage, carrots, cauliflower, cherries, chili clover, chickpea seeds, coffee, corn, cotton, cucumbers, cucurbits, grapefruits kiwi, lemons, lettuce, limes, maize, melon, mushrooms, oil seed rape, olive, onions, oranges, ornamentals such as roses pasture, peaches, peanuts, pears, peas, peppers, peppermint, pineapples, plums, pome and stone fruits, potatoes, pumpkin, rice, sorghum, soybean, spinach, sugar cane, sunflower, sweat potato, table and wine grapes, tobacco, tomatoes, tree nuts, walnuts, watermelon, wheat and yucca.

29. The method for controlling pests according to claim 28, wherein the crop is brassicas, cotton, cucurbits, peppers, pineapples, grapes, and tomatoes.

30. The method for protecting crop according to any of claims 27-29, wherein the pest is ants, aphids, armyworms, beetles, caterpillar, chinch bugs, grasshopper, fruit borers, leafhopper, leafminer, leafrollers loopers, maggots, mealybug, mites, nematodes, psyllids, rust flies, sawfly, scales, slugs, thrips, tubeworms, whitefly, white grubs, wireworm, webworm, weevils.

31. The method for protecting crop according to any of claims 27-30, wherein the pest is at least one of Aphis gossypii, Myzus persicae, Thrips tabaci, Frankliniela occidentalis, Empoasca vitis, Tetranychus urticae, and Bemisia tabaci.

32. The method according to any of claims 22-31, wherein the application rate of the insecticidal mixture according to any of claims 1-21, is from 10 g/ha to 1000 g/ha.

33. The method according to any of claims 22-32, wherein the insecticidal mixture according to any of claims 1-21, is applied on the crop or on the soil where the crop is growing.

34. The method according to any of claims 22-33, wherein the insecticidal mixture according to any of claims 1-21, enhance the health of a plant.

35. Use according to any of claims 22-34, wherein the insecticidal mixture according to any of claims 1-21 is synergistic.
